(19) United States
(12) Patent Application Publication
(10) Pub. No.: US 2012/0060373 A1
(43) Pub. Date: Mar. 15, 2012

(54) Pizza slice cutting stamp

(76) Inventor: Ryan P. Spreen, Lambertville, NJ (US)

(21) Appl. No.: 12/807,587

(22) Filed: Sep. 9, 2010

(51) Int. Cl. A21C 15/04

(52) U.S. Cl. 30/114

(57) ABSTRACT

A pizza slice cutting stamp for creating bite size pizza portions from a single slice of pizza includes a cutting stamp frame having a predetermined top view footprint, and an outer support peripheral member that is a structural support and a cutting blade. The cutting stamp frame also has a plurality of inner blade members connected to one another and to the outer support peripheral member to establish a plurality a bite-size closed loop cutting patterns for creating a plurality of bite size portions from a single slice of pizza. The cutting stamp frame has a triangular footprint. A handle cover functionally connected to the cutting stamp frame is adapted to be held by a single hand for pressing said cutting stamp frame on a pizza slice. A user may utilize the cutting stamp frame by placing it on a slice of pizza and pressing on the handle cover to create a plurality of bite size portions from a single slice of pizza. The cutting stamp frame may also be reversible with two sets of inner blade members that may be separated by a solid plate therebetween.

### BACKGROUND OF INVENTION

a. Field of Invention

The invention relates generally to pizza cutters, and more specifically to the need for cutting a pizza slice into small pieces for children, toddlers and infants. Thus, the present invention pizza cutter is a pizza slice-cutting stamp to create bite-size pieces from a single slice. In some embodiments, it involves a single blade pattern and in other embodiments, reversible blade patterns so that it provides a user option for choices, such as larger or smaller cuts, or different patterns. The present invention stamp may also have a carrying case or container that holds both the stamp and leftover or precut pizza bite-size pieces.

b. Description of Related Art

The following patents are representative of the field pertaining to the present invention:

U.S. Pat. No. 6,557,260 to Morris describes a pizza cutting device that allows the user to cut a pizza in uniform, evenly-sized pieces on a consistent basis. The cutter consists of a circular frame that has a series of blades spanning across its hollow interior diameter. Sized so that the entire pizza fits within the interior diameter, the user simply presses down on a pair of handles located on the outside of the frame and the blades cut the pizza into uniform, even slices.

U.S. Pat. No. 5,613,431 to Tateno describes a tool for use on an avocado, for separating the meat of an avocado from its skin while simultaneously cutting the meat into separate slices, comprising a handle having a first end and a second end and a frame mounted at one end of the handle. The frame has a cutter fastener portion and a handle fastening portion operably secured to the handle and extending away therefrom. A plurality of cutting elements are operably positioned on the frame. An elongated adjustment element extends through the handle and into the frame. A first end of the elongated adjustment element is secured to the plurality of cutting elements and a second end is secured to a rotatable adjustment knob. Fastening elements are slidably secured to the cutter fastener portion of the frame and to the handle fastening portion of the frame allowing the cutter fastening portion of the frame and the handle fastening portion of the frame to be adjusted in relationship to each other.

U.S. Pat. No. 5,579,582 to Carlson describes a puzzle cookie cutter that includes a cutting die holder and at least one cutting die removably securable in the holder. The die or dies provide for the cutting of cookie dough, batter, or the like into several separate, irregularly shaped and sized interfitting pieces, which pieces may be reassembled as a puzzle after baking to provide entertainment for the consumer of the cookie. The dies may be provided in virtually any regular or irregular geometric shape, animal or other caricature or representation, and/or any alphanumeric character, as desired. The die or dies may also provide for the spaced apart separation of the cut dough or batter, to allow for expansion or flow of the batter or dough during the baking process, in order that the baked pieces will have a close fit with one another without interference. The cut pieces may be baked adjacent one another on a sheet or pan and decorated after the baking process as desired, then separated randomly to provide a challenge akin to that of the assembly of a relatively simple jigsaw or picture puzzle, in addition to the enjoyment of eating the baked cookie pieces.

U.S. Pat. No. 5,098,013 to France et al. describes a tray for transporting a single slice of pizza while facilitating use of the tray as a support so that the piece of pizza can be removed from and repositioned on the tray during eating thereof The tray includes a generally triangular bottom wall and a pair of low-height sidewalls that extend along opposite identical side edges of the bottom wall. The other or base edge of the tray is open to facilitate movement of a piece of pizza either onto or off of the tray. The tray is formed from a flat blank constructed preferably of corrugated paperboard, with fold lines separating the low sidewalls from the bottom wall so that the sidewalls can be folded upwardly to be generally perpendicular to the bottom wall. One of the side walls has a latching tab integrally associated therewith and foldable so as to wrap around one end of the other side wall for insertion into an elongate slot which extends along the fold between the other side wall and the bottom wall to latch the tray in its assembled position.

U.S. Pat. No. 4,998,348 to Foate describes a cutting implement and method for subdividing sandwiches such as hamburgers into pieces that a toddler or small child can handle. The food processor includes a circular frame approximately two inches in height which is attached to five equally spaced parallel cutting blades which are also approximately two inches in height; two opposed upwardly and outwardly disposed handles are used simultaneously to cut a sandwich such as a hamburger into strips of approximately one inch in width. The cutting may be done on a piece of cardboard of the same approximate size or slightly larger than the food being cut so that the food is held together during the withdrawal of the food processing cutting implement and during the process of serving the cut up food. During the cutting action the cardboard cutting board is not cut through although the surface may be indented by the cutting blades.

U.S. Pat. No. 4,195,402 to Leifer describes a dessert cutter particularly useful for delicate cakes with soft and moist composition. A frame supports a plurality of taut wires in a geometric relationship. The frame provides a grip for pressing the wires through a cake and a guide surface for visual alignment during the cutting application.

U.S. Design Pat. Des. 586,189 to Austin illustrates the ornamental design for a cutting tool. The tool is round and appears to be for a full size round pie, cake or cheese to create crescent cuts.

U.S. Design Pat. Des. 455,318 to Miller illustrates the ornamental design for a pizza slice container with raised detents, as shown and described.

U.S. Design Pat. Des. 420,865 to Levy illustrates the ornamental design for a combined multi-cake slicer and storage pack. It has a rectangular peripheral footprint and rectangular cuts.

U.S. Design Pat. Des. 420,259 to Laib illustrates the ornamental design for a cake slicer to create repeat wedge slices of a cake.

U.S. Design Pat. Des. 413,771 to So illustrates the ornamental design for a cutter that is typically used to cut small cheese cubes. It is a rocking device.

U.S. Design Pat. Des. 358,969 to Romanoff illustrates the ornamental design for pizza cutter, as shown and described, having a rectangular outer shape and eight rectangular sections divided in two diagonally. It appears to be a cutter for rectangular Sicilian pizza to create right angle triangular slices therefrom.

United States Patent Application 2005/0181098 A1 to Montague describes a method of cutting an outline of an inner circular piece in the center of a pizza then further dividing the resulting outer piece into truncated wedges results in improved retention of pizza toppings on the tip of the wedge during separation from the rest of the pizza. Brand strengthening will occur if the inner piece is instead cut into a shape resembling the company's trademark. As well, apparatus similar to a cookie cutter with a strengthened and sharpened blade is disclosed.

Notwithstanding the prior art, the present invention is neither taught nor rendered obvious thereby.

### SUMMARY OF INVENTION

The present invention is directed to a pizza slice cutting stamp for creating bite size pizza portions from a single slice of pizza. It includes a cutting stamp frame that has a predetermined top view footprint, and an outer support peripheral member that is a structural support and a cutting blade. The cutting stamp frame also has a plurality of inner blade members connected to one another and to the outer support peripheral member to establish a plurality a bite-size closed loop cutting patterns for creating a plurality of bite size portions from a single slice of pizza. The cutting stamp frame has a triangular footprint and a handle cover functionally connected to the cutting stamp frame. The handle is adapted to be held by a single hand for pressing the cutting stamp frame on a pizza slice.

In some preferred embodiments of the present invention pizza slice cutting stamp for creating bite size pizza portions from a single slice of pizza, the cutting stamp frame is plastic.

In some other preferred embodiments of the present invention pizza slice cutting stamp for creating bite size pizza portions from a single slice of pizza, the cutting stamp frame is metal.

In some preferred embodiments of the present invention pizza slice cutting stamp for creating bite size pizza portions from a single slice of pizza, the plurality of bite-size closed loop cutting patterns is a set of triangular bite-size closed loop cutting patterns.

In some preferred embodiments of the present invention pizza slice cutting stamp for creating bite size pizza portions from a single slice of pizza, the plurality of bite-size closed loop cutting patterns includes patterns having shapes selected from the group consisting of circular, rectangular, square, irregular and combinations thereof.

In some other preferred embodiments of the present invention pizza slice cutting stamp for creating bite size pizza portions from a single slice of pizza, the plurality of bite-size closed loop cutting patterns includes patterns having shapes selected from the group consisting of circular, rectangular, square, irregular and combinations thereof.

In some preferred embodiments of the present invention pizza slice cutting stamp for creating bite size pizza portions from a single slice of pizza, the pizza slice cutting stamp further includes a base container adapted to receive the cutting stamp frame and the handle cover and adapted to connect with at least one of the cutting stamp frame and the handle cover.

In some preferred embodiments of the present invention pizza slice cutting stamp for creating bite size pizza portions from a single slice of pizza, the pizza slice cutting stamp further includes a base container adapted to receive a the cutting stamp frame and the handle cover and adapted to connect with at least one of the cutting stamp frame and the handle cover.

In some preferred embodiments of the present invention pizza slice cutting stamp for creating bite size pizza portions from a single slice of pizza, the cutting stamp frame and the handle cover are a single uninstructural element.

In some other preferred embodiments of the present invention pizza slice cutting stamp for creating bite size pizza portions from a single slice of pizza, the cutting stamp frame and the handle cover are a single uninstructural element.

In some other preferred embodiments, the present invention pizza slice cutting stamp for creating bite size pizza portions from a single slice of pizza, the pizza slice cutting stamp for creating bite size pizza portions from a single slice of pizza includes a reversible cutting stamp frame having a top and a bottom and having a predetermined top view peripheral footprint, and an outer support peripheral member that is a structural support and a cutting blade. The cutting stamp frame also has a first plurality of inner blade members connected to one another and to the outer support peripheral member on the top to establish a first plurality of bite-size closed loop cutting patterns for creating a plurality of bite size portions from a single slice of pizza and has a second plurality of inner blade members connected to one another and to the outer support peripheral member on the bottom to establish a second plurality of bite-size close loop cutting patterns for creating a plurality of bite-size portions from a single slice of pizza. The first plurality of inner blades and the second plurality of inner blade have patterns different from one another. A handle cover is functionally connected to the cutting stamp frame and adapted to be held by a single hand for pressing the cutting stamp frame on a pizza slice wherein a user may utilize the cutting stamp frame in the handle cover with the second plurality of inner blade members facing downwardly to utilize the second plurality of inner blade members to cut a slice of pizza. A user may alternatively reverse the cutting stamp frame relative to the handle cover with the first plurality of inner blade members facing downwardly to utilize the first plurality of inner blade members to cut a slice of pizza.

In some other preferred embodiments of the present invention pizza slice cutting stamp for creating bite size pizza portions from a single slice of pizza, the cutting stamp frame first plurality of inner blade members and the second plurality of inner blade members have a solid plate located therebetween.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a top perspective view of an embodiment of a present invention pizza slice cutting stamp;

FIG. 2 is a back view of the embodiment of the present invention pizza slice cutting stamp shown in FIG. 1;

FIG. 3 is a top perspective view of another embodiment of the present invention outer support peripheral member with an alternate blade pattern;

FIG. 4 is a top perspective view of an embodiment of a present invention pizza slice cutting stamp with a reversible cutting stamp frame;

FIG. 5 is a back view of the embodiment of the present invention pizza slice cutting stamp shown in FIG. 4;

FIG. 6 is a top perspective view of another embodiment of the present invention pizza slice cutting stamp with a reversible cutting stamp frame;

FIG. 7 is a top perspective of the present invention pizza slice cutting stamp from FIG. 3 in use on a slice of pizza;

FIG. 8 illustrates the slice of pizza from FIG. 7 after the pizza slice cutting stamp has been used once;

FIG. 9 is a top perspective of the present invention pizza slice cutting stamp from FIG. 3 in use again on the slice of pizza from FIG. 7 and FIG. 8;

FIG. 10 is a top perspective of the present invention pizza slice cutting stamp from FIG. 1 and FIG. 2 in use on a slice of pizza;

FIG. 11 illustrates the slice of pizza from FIG. 10 after the pizza slice cutting stamp has been used once;

FIG. 12 is a top perspective view of another embodiment of the present invention pizza slice cutting stamp with an alternate pattern of bite-size cutting loops;

FIG. 13 is a back view of the embodiment of the present invention pizza slice cutting stamp shown in FIG. 12;

FIG. 14 is a top perspective view of another embodiment of the present invention pizza slice cutting stamp with an alternate pattern of bite-size cutting loops; and,

FIG. 15 is a front view of another embodiment of a present invention pizza slice cutting stamp and base container.

### DETAILED DESCRIPTION OF THE EMBODIMENTS

Referring now in detail to the drawings wherein like reference numerals designate corresponding parts throughout the several views, various embodiments of the present invention are shown.

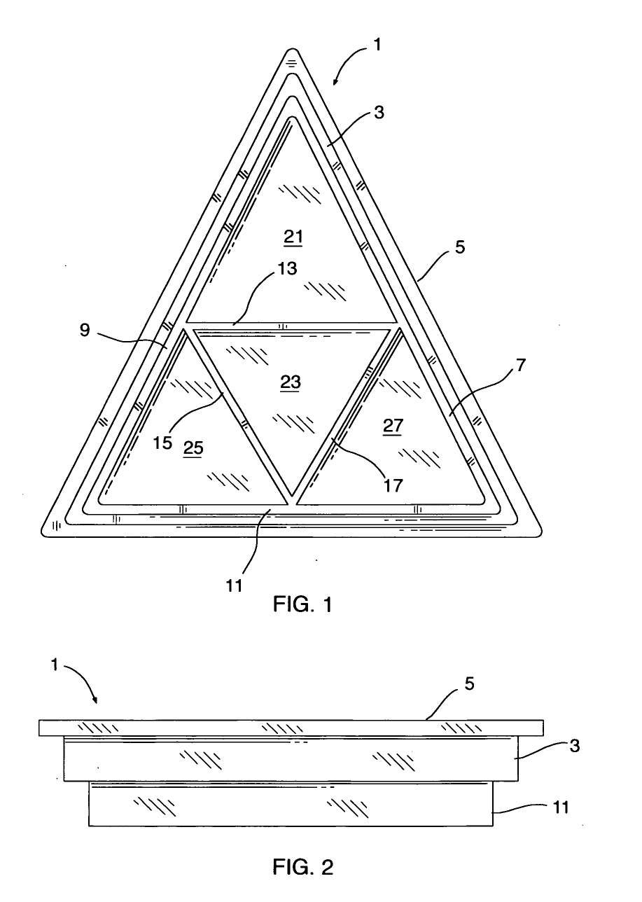

FIG. 1 is a top perspective view of an embodiment of a present invention pizza slice cutting stamp 1, FIG. 2 is a back view of the embodiment of the present invention pizza slice cutting stamp 1 shown in FIG. 1. These two Figures are discussed collectively with the understanding that not all reference numerals are in all Figures.

A pizza slice cutting stamp 1 for creating bite size pizza portions from a single slice of pizza comprises a cutting stamp frame 3 having a predetermined top view footprint, and having an outer support peripheral member 7, 9, 11 that is a structural support and a cutting blade. As illustrated in FIG. 1, the cutting stamp frame 3 has a triangular footprint. The cutting stamp frame 3 also having a plurality of inner blade members 13, 15, 17 connected to one another and to the outer support peripheral members 7, 9, 11 to establish four bite-size closed loop cutting patterns 21, 23, 25, 27 for creating a plurality of bite size portions from a single slice of pizza, not shown. In the present embodiment of the pizza slice cutting stamp 1, the four bite-size closed loop cutting patterns 21, 23, 25, 27 are triangular.

A handle cover 5 is functionally connected to the cutting stamp frame 3 and adapted to be held by a single hand for pressing the cutting stamp frame 3 on a pizza slice. In the present embodiment of the pizza slice cutting stamp 1, the cutting stamp frame 3 and the handle cover 5 are a single uninstructural element. Cutting stamp frame 3 may be made from plastic or metal.

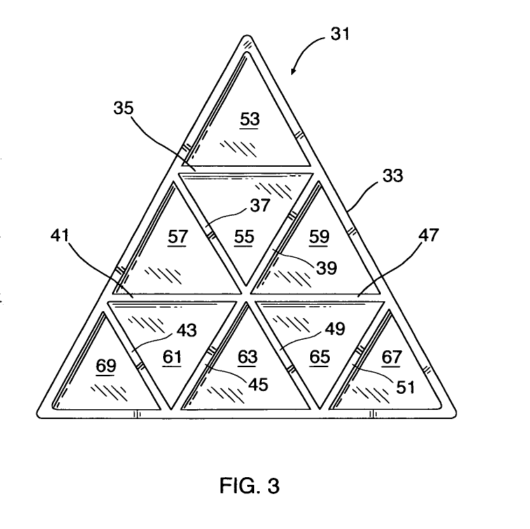

FIG. 3 is a top perspective view of another embodiment of the present invention pizza slice cutting stamp 31 highlighting outer support peripheral member 33 with an alternate blade pattern. Outer support peripheral member 33 is a structural support and a cutting blade. Inner blade members 35, 37, 39, 41, 43, 45, 47, 49, 51 connected to one another and to the outer support peripheral member 33 to establish nine bite-size closed loop cutting patterns 53, 55, 57, 59, 61, 63, 65, 67, 69 for creating a plurality of bite size portions from a single slice of pizza, not shown.

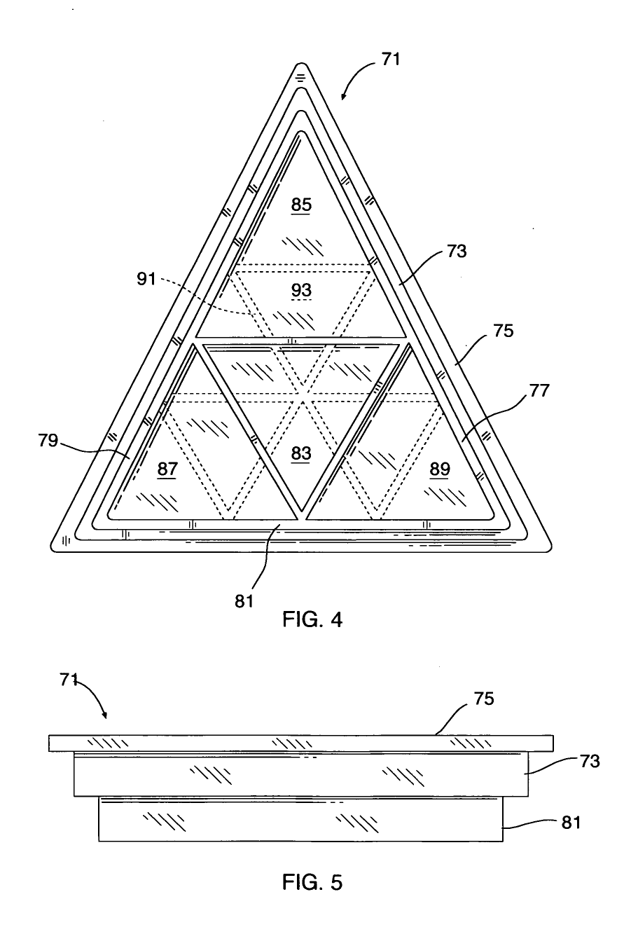

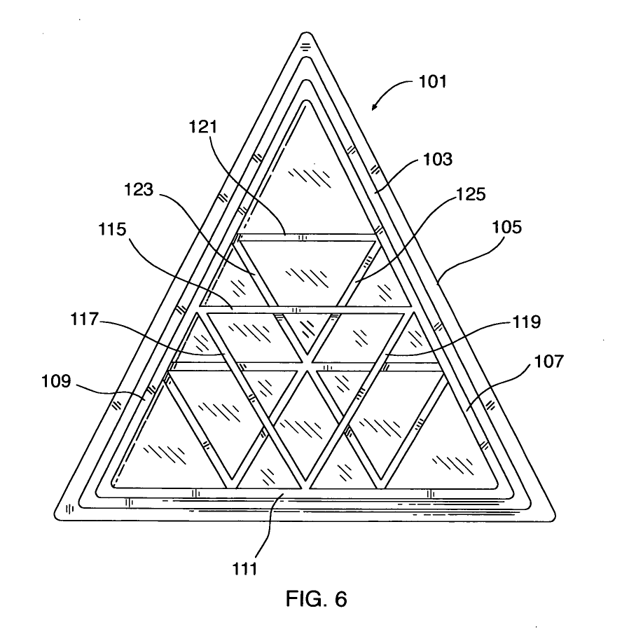

FIG. 4 is a top perspective view of an embodiment of a present invention pizza slice cutting stamp 71 with reversible cutting stamp frame 73 and handle cover 75, FIG. 5 is a back view of the embodiment of the present invention pizza slice cutting stamp 71 shown in FIG. 4. These two Figures are discussed collectively with the understanding that not all reference numerals are in all Figures.

A pizza slice cutting stamp 71 for creating bite size pizza portions from a single slice of pizza comprises a cutting stamp frame 73 having a predetermined top view footprint, and having an outer support peripheral member 77, 79, 81 that is a structural support and a cutting blade. As illustrated in FIG. 4, the reversible cutting stamp frame 73 has a triangular footprint. The reversible cutting stamp frame 73 also has a plurality of inner blade members similar to those in FIG. 1 connected to one another and to the top of outer support peripheral members 77, 79, 81 to establish a first plurality of bite-size closed loop cutting patterns 83, 85, 87, 89 for creating a first plurality of bite size portions from a single slice of pizza, not shown. A second plurality of inner blade members 91 are connected to one another and to the bottom of outer support peripheral members 77, 79, 81 to establish a second plurality of bite-size closed loop cutting patterns. A common central surface 93 separates the first plurality of inner blade members and second plurality of inner blade members 91.

A handle cover 75 is functionally connected to the cutting stamp frame 73 and adapted to be held by a single hand for pressing the cutting stamp frame 73 on a pizza slice. Cutting stamp frame 73 may be made from plastic or metal.

FIG. 6 is a top perspective view of another embodiment of the present invention pizza slice cutting stamp 101 with a reversible cutting stamp frame 103. Reversible cutting stamp frame 103 has a predetermined top view peripheral footprint, and has an outer support peripheral member 107, 109, 111 that is a structural support and a cutting blade. The cutting stamp frame 103 also has a first plurality of inner blade members 115, 117, 119 connected to one another and to the top of outer support peripheral member 107, 109, 111 to establish a first plurality of bite-size closed loop cutting patterns for creating a plurality of bite size portions from a single slice of pizza. A second plurality of inner blade members 121, 123, 125 is connected to one another and to the bottom of outer support peripheral member 107 to establish a second plurality of bite-size close loop cutting patterns for creating a plurality of bite-size portions from a single slice of pizza. Unlike the embodiment of the present invention described in FIG. 4 and FIG. 5, there is no central surface separating the first and second plurality of blades in the present embodiment of the pizza slice cutting stamp 101. The first plurality of inner blades 115, 117, 119 and the second plurality of inner blade 121, 123, 125 have patterns different from one another.

A handle cover 105 is functionally connected to the cutting stamp frame 103 and adapted to be held by a single hand for pressing the cutting stamp frame 103 on a pizza slice. Cutting stamp frame 103 may be made from plastic or metal.

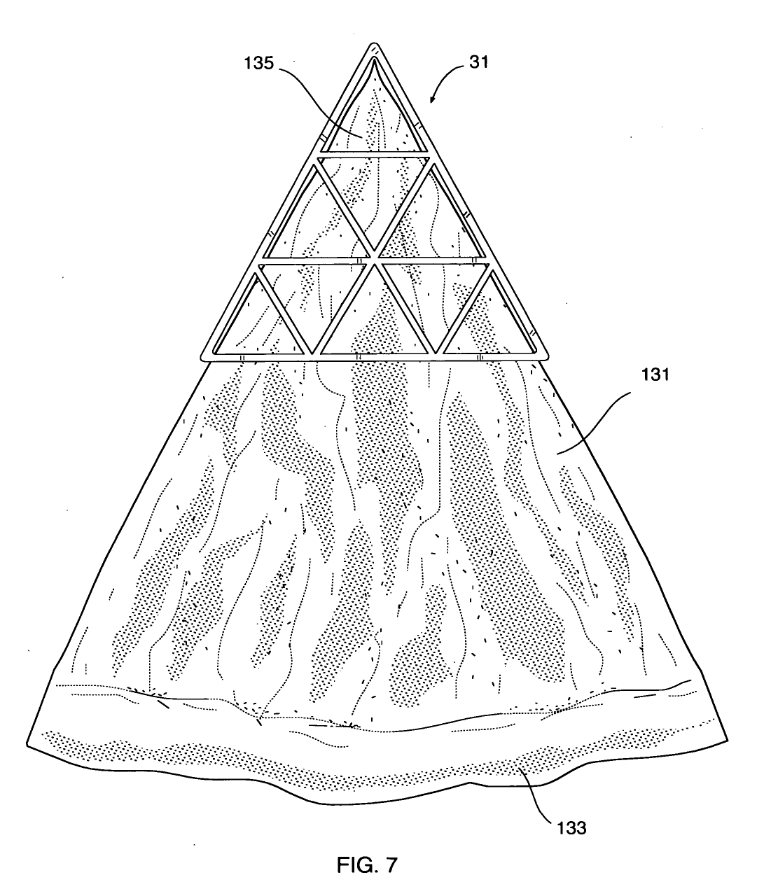

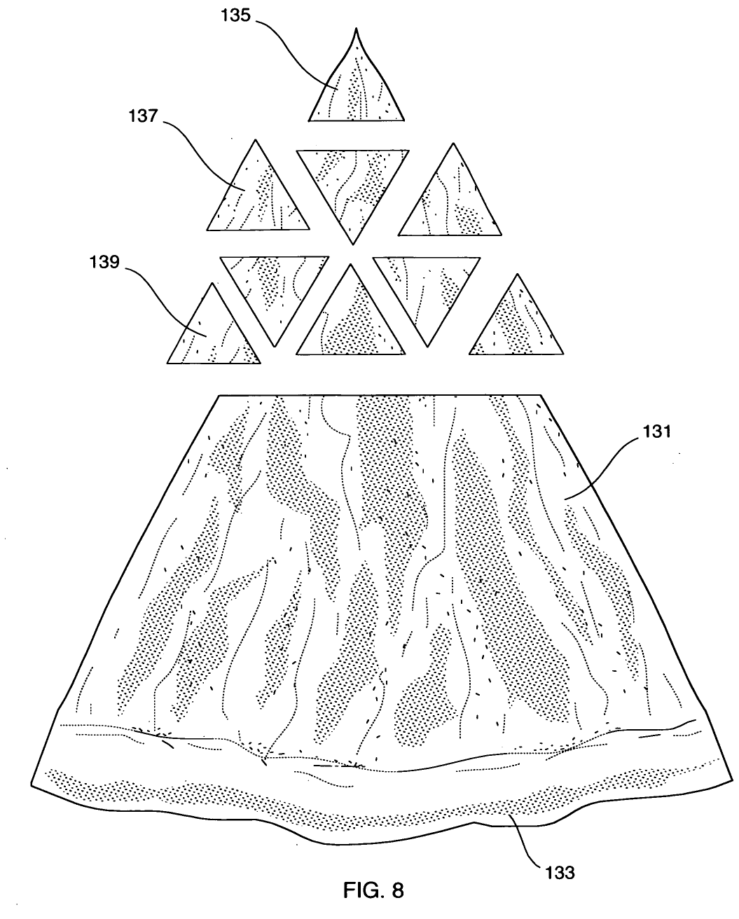

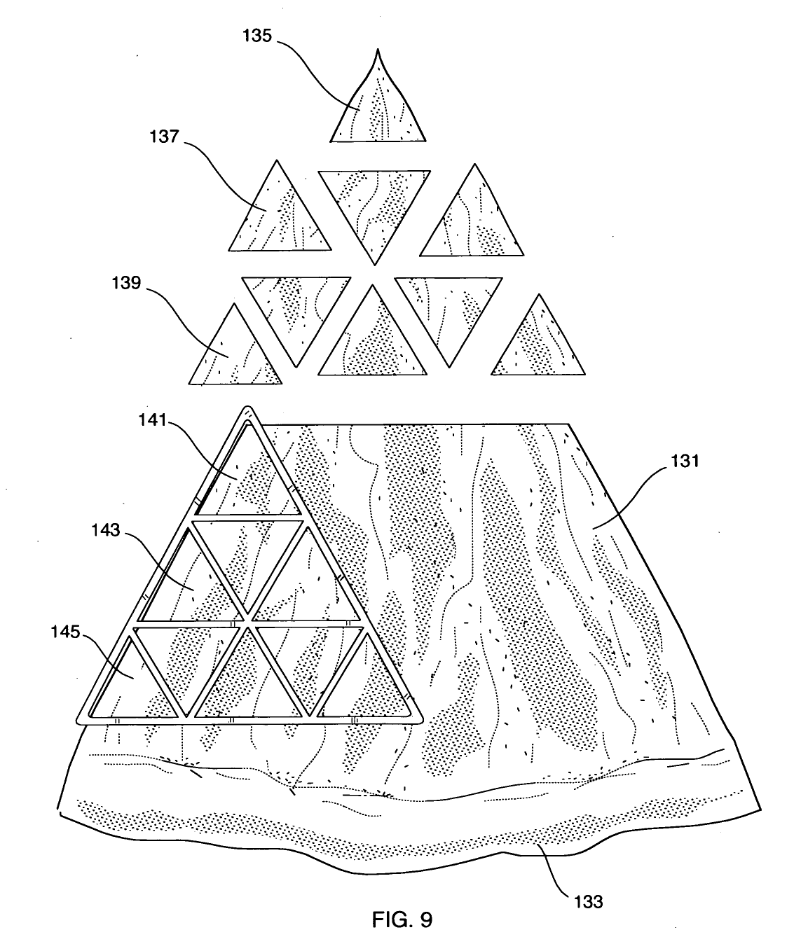

FIG. 7 is a top perspective of the present invention pizza slice cutting stamp 31 from FIG. 3 in use on a slice of pizza 131, FIG. 8 illustrates the slice of pizza 131 from FIG. 7 after the pizza slice cutting stamp 31 has been has been used once on the slice of pizza 131 and FIG. 9 illustrate the placement of pizza slice cutting stamp 31 for a second use on the slice of pizza 131. These three Figures are discussed collectively with the understanding that not all reference numerals are in all Figures. Pizza slice cutting stamp 31 is formed as described above with the understanding that not all reference numerals are in all Figures.

In FIG. 7, pizza slice cutting stamp 31 is aligned with the point of the slice of pizza 131 farthest from the crust 133 to maximize the area cut. The user then presses on cutting stamp 31 as described above to create a first plurality of bite-size portions 135, 137, 139. Once the pizza slice cutting stamp 31 is removed, a plurality of bite-size portions 135, 137, 139 can be accessed as shown in FIG. 8 and a second cut can be made. As shown in FIG. 9, the pizza slice cutting stamp 31 can be aligned with the edge of the slice of pizza 131 to maximize the area cut. When the user presses down on cutting stamp 31 in this position, a second plurality of bite-size portions 141, 143, 145 will be created. Additional cuts can be made using the pizza slice cutting stamp 31 in this manner until only the crust 133 remains.

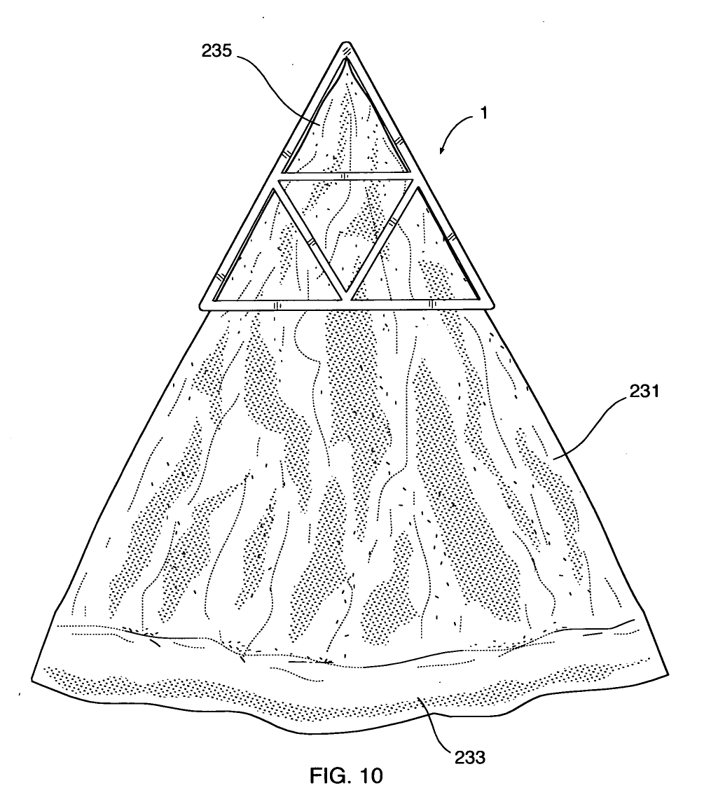

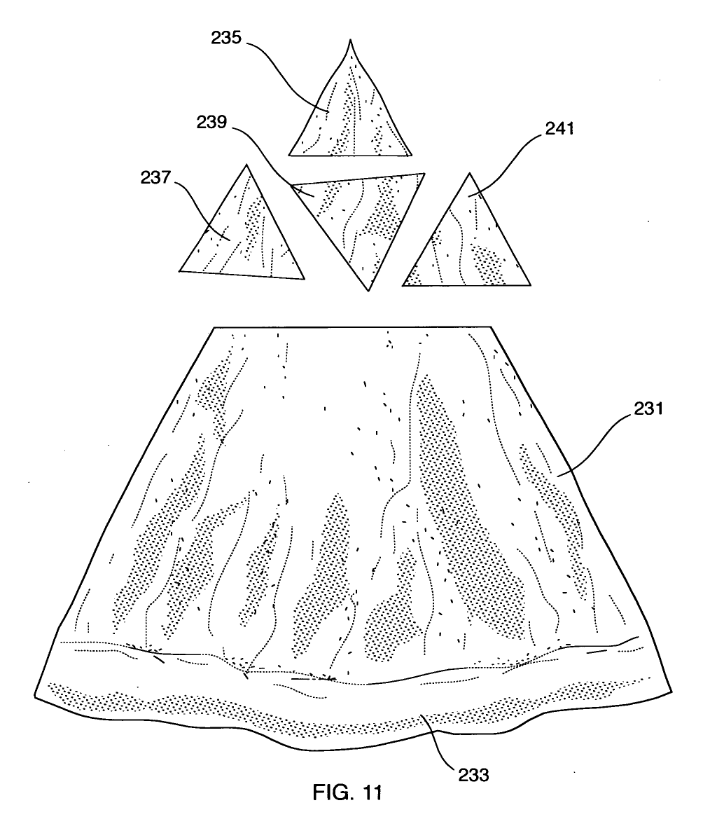

FIG. 10 is a top perspective of the present invention pizza slice cutting stamp 1 from FIG. 1 in use on a slice of pizza 231 and FIG. 11 illustrates the slice of pizza 231 from FIG. 10 after the pizza slice cutting stamp 1 has been has been used once on the slice of pizza 231. These two Figures are discussed collectively with the understanding that not all reference numerals are in all Figures. Pizza slice cutting stamp 1 is formed as described above with the understanding that not all reference numerals are in all Figures.

In FIG. 10, pizza slice cutting stamp 1 is aligned with the point of the slice of pizza 231 farthest from the crust 233 to maximize the area cut. The user then presses on cutting stamp 1 as described in FIG. 1 to create a first plurality of bite-size portions 235, 237, 239, 241. Once the pizza slice cutting stamp 1 is removed, plurality of bite-size portions 235, 237, 239, 241 can be accessed as shown in FIG. 11. Additional cuts can be made using the pizza slice cutting stamp 1 in the manner described in FIGS. 7, 8 and 9 above until only the crust 233 remains.

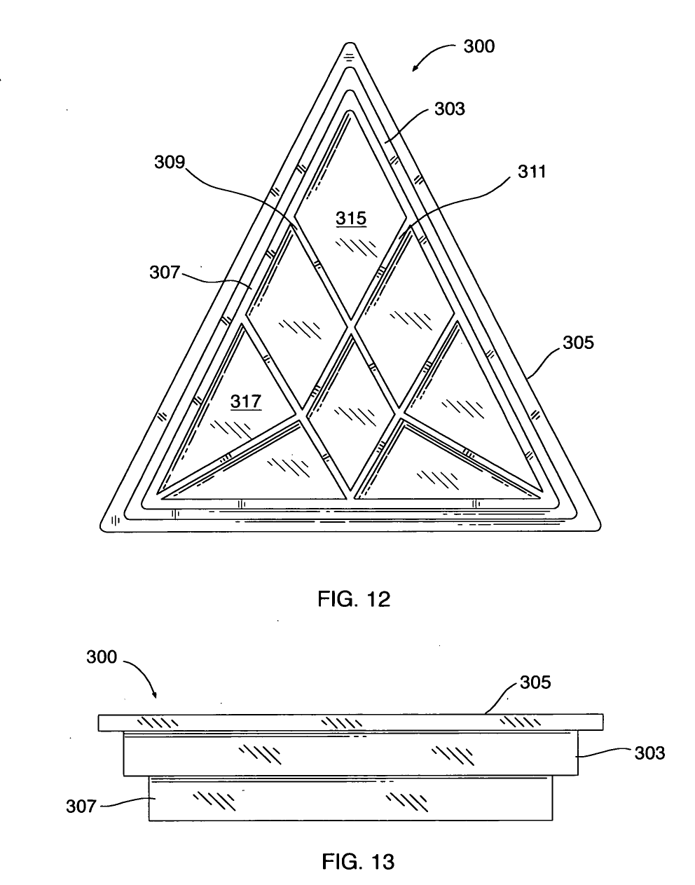

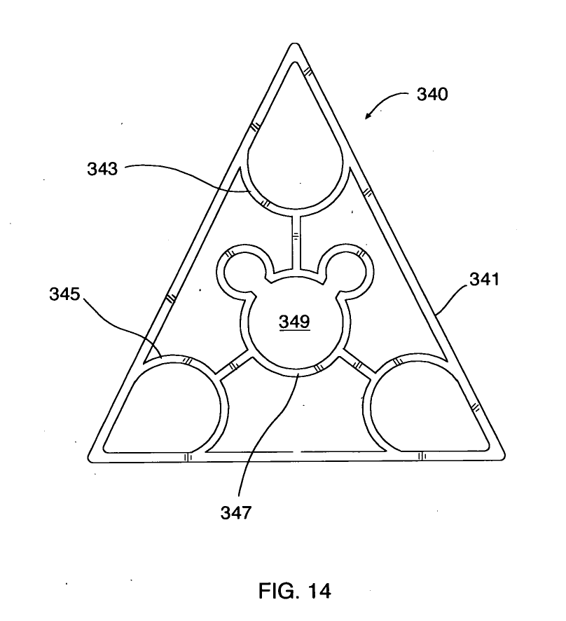

FIG. 12 is a top perspective view of an embodiment of a present invention pizza slice cutting stamp 300, FIG. 13 is a back view of the embodiment of the present invention pizza slice cutting stamp 300 shown in FIG. 12. These two Figures are discussed collectively with the understanding that not all reference numerals are in all Figures.

A pizza slice cutting stamp 300 for creating bite size pizza portions from a single slice of pizza comprises a cutting stamp frame 303 having a predetermined top view footprint, and having an outer support peripheral member 307 that is a structural support and a cutting blade. As illustrated in FIG. 12, the cutting stamp frame 303 has a triangular footprint. The cutting stamp frame 303 also having a plurality of inner blade members 307, 309, 311 connected to one another and to the outer support peripheral member 307 to establish a plurality of bite-size closed loop cutting patterns 315, 317 for creating a plurality of bite size portions from a single slice of pizza, not shown. In the present embodiment of the pizza slice cutting stamp 300, bite-size closed loop cutting pattern 315 is irregular and bite-size closed loop cutting pattern 317 is triangular, although it is to be understood that bite-size closed loop cutting patterns 315 and 317 could have any shape selected from the group consisting of circular, rectangular, square, irregular and combinations thereof.

A handle cover 305 is functionally connected to the cutting stamp frame 303 and adapted to be held by a single hand for pressing the cutting stamp frame 303 on a pizza slice. In the present embodiment of the pizza slice cutting stamp 300, the cutting stamp frame 303 and the handle cover 305 are a single uninstructural element. Cutting stamp frame 303 may be made from plastic or metal.

FIG. 14 is a top perspective view of another embodiment of the present invention pizza slice cutting stamp 340 highlighting outer support peripheral member 341 with an alternate blade pattern. Outer support peripheral member 341 is a structural support and a cutting blade. Inner blade members 343, 345, 347 connected to one another and to the outer support peripheral member 341 to establish a plurality of bite-size closed loop cutting patterns 349 for creating a plurality of bite size portions from a single slice of pizza, not shown. As illustrated in FIG. 14, the plurality of bite-size closed loop cutting patterns may include patterns having shapes selected from the group consisting of circular, rectangular, square, irregular and combinations thereof

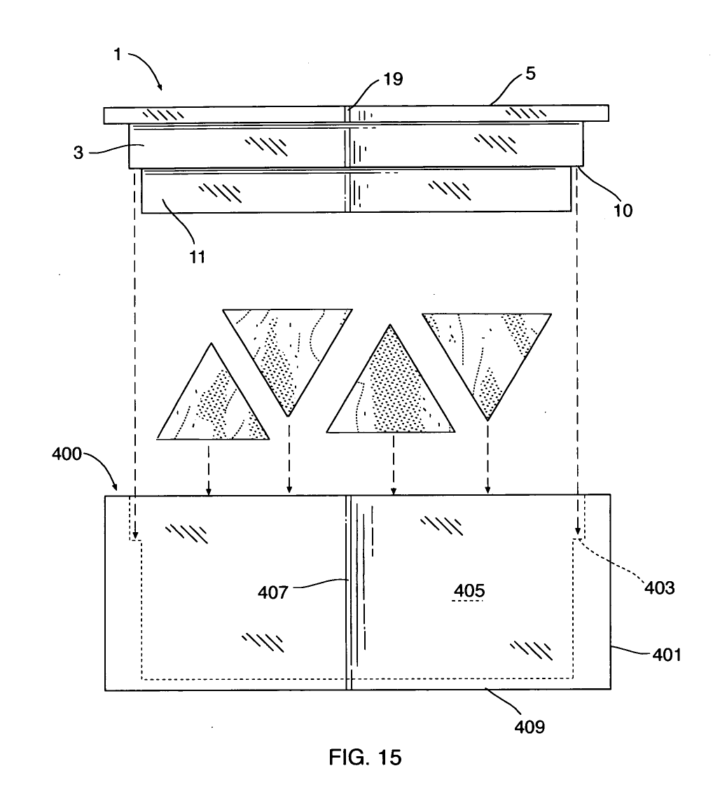

FIG. 15 is a front view of another embodiment of a present invention pizza slice cutting stamp 1 and base container 400. Pizza slice cutting stamp 1 is formed as described above in FIG. 1 and FIG. 2 with a cutting stamp frame 3 having a predetermined top view footprint, an outer support peripheral member 11 and handle cover 5. The front point of present invention pizza slice cutting stamp 1 appears as a vertical seam 19 in the present view.

Base container 400 is adapted to receive pizza slice cutting stamp 1 and adapted to connect with at least one of the cutting stamp frame 3 and handle cover 5. Base container 400 is formed by walls 401 and bottom 409. The top view footprint of base container 400 reflects that of pizza slice cutting stamp 1, with a front point appearing as a vertical seam 407. The cavity 405 within the walls 401 of base container 400 will receive the cutting stamp frame 3 and outer support peripheral member 11 when the two pieces are connected. Surface 10 on the pizza slice cutting stamp 1 and surface 403 on base container 400 will come into contact with each other when pizza slice cutting stamp 1 and base container 400 are connected. The pizza slice cutting stamp 1 and base container 400 will be held together using a soft force fit or snap connection to ensure that contents are securely held.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A pizza slice cutting stamp for creating bite size pizza portions from a single slice of pizza, which comprises:
a) a cutting stamp frame having a predetermined top view footprint, and having an outer support peripheral member that is a structural support and a cutting blade, said cutting stamp frame also having a plurality of inner blade members connected to one another and to said outer support peripheral member to establish a plurality a bite-size closed loop cutting patterns for creating a plurality of bite size portions from a single slice of pizza, said cutting stamp frame having triangular footprint; and,
b) a handle cover functionally connected to said cutting stamp frame and adapted to be held by a single hand for pressing said cutting stamp frame on a pizza slice.

2. The pizza slice cutting stamp for creating bite size pizza portions from a single slice of pizza of claim 1 wherein said cutting stamp frame is plastic.

3. The pizza slice cutting stamp frame of claim 1 wherein said cutting stamp frame is metal.

4. The pizza slice cutting stamp for creating bite size pizza portions from a single slice of pizza of claim 1 wherein said plurality of bite-size closed loop cutting patterns is a set of triangular bite-size closed loop cutting patterns.

5. The pizza slice cutting stamp for creating bite size pizza portions from a single slice of pizza of claim 1 wherein said plurality of bite-size closed loop cutting patterns includes patterns having shapes selected from the group consisting of circular, rectangular, square, irregular and combinations thereof.

6. The pizza slice cutting stamp for creating bite size pizza portions from a single slice of pizza of claim 2 wherein said plurality of bite-size closed loop cutting patterns includes patterns having shapes selected from the group consisting of circular, rectangular, square, irregular and combinations thereof

7. The pizza slice cutting stamp for creating bite size pizza portions from a single slice of pizza of claim 1 wherein said pizza slice cutting stamp further includes a base container adapted to receive a said cutting stamp frame and said handle cover and adapted to connect with at least one of said cutting stamp frame and said handle cover.

8. The pizza slice cutting stamp for creating bite size pizza portions from a single slice of pizza of claim 2 wherein said pizza slice cutting stamp further includes a base container adapted to receive a said cutting stamp frame and said handle cover and adapted to connect with at least one of said cutting stamp frame and said handle cover.

9. The pizza slice cutting stamp for creating bite size pizza portions from a single slice of pizza of claim 1 wherein said cutting stamp frame and said handle cover are a single uninstructural element.

10. The pizza slice cutting stamp for creating bite size pizza portions from a single slice of pizza of claim 2 wherein said cutting stamp frame and said handle cover are a single uninstructural element.

11. A pizza slice cutting stamp for creating bite size pizza portions from a single slice of pizza, which comprises:
a) a reversible cutting stamp frame having a top and a bottom and having a predetermined top view peripheral footprint, and having an outer support peripheral member that is a structural support and a cutting blade, said cutting stamp frame also having a first plurality of inner blade members connected to one another and to said outer support peripheral member on said top to establish a first plurality of bite-size closed loop cutting patterns for creating a plurality of bite size portions from a single slice of pizza and having a second plurality of inner blade members connected to one another and to said outer support peripheral member on said bottom to establish a second plurality of bite-size close loop cutting patterns for creating a plurality of bite-size portions from a single slice of pizza, wherein said first plurality of inner blades and said second plurality of inner blade have patterns different from one another; and,
b) a handle cover functionally connected to said cutting stamp frame and adapted to be held by a single hand for pressing said cutting stamp frame on a pizza slice;
wherein a user may utilize said cutting stamp frame in said handle cover with said second plurality of inner blade members facing downwardly to utilize said second plurality of inner blade members to cut a slice of pizza and may alternatively reverse said cutting stamp frame relative to said handle cover with said first plurality of inner blade members facing downwardly to utilize said first plurality of inner blade members to cut a slice of pizza.

12. The pizza slice cutting stamp for creating bite size pizza portions from a single slice of pizza of claim 11 wherein said cutting stamp frame has a triangular footprint.

13. The pizza slice cutting stamp for creating bite size pizza portions from a single slice of pizza of claim 11 wherein said plurality of bite-size closed loop cutting patterns is a set of triangular bite-size closed loop cutting patterns.

14. The pizza slice cutting stamp for creating bite size pizza portions from a single slice of pizza of claim 12 wherein said plurality of bite-size closed loop cutting patterns is a set of triangular bite-size closed loop cutting patterns

15. The pizza slice cutting stamp for creating bite size pizza portions from a single slice of pizza of claim 11 wherein said plurality of bite-size closed loop cutting patterns includes patterns having shapes selected from the group consisting of circular, rectangular, square, irregular and combinations thereof.

16. The pizza slice cutting stamp for creating bite size pizza portions from a single slice of pizza of claim 12 wherein said plurality of bite-size closed loop cutting patterns includes patterns having shapes selected from the group consisting of circular, rectangular, square, irregular and combinations thereof

17. The pizza slice cutting stamp for creating bite size pizza portions from a single slice of pizza of claim 11 wherein said pizza slice cutting stamp further includes a base container adapted to receive a said cutting stamp frame and said handle cover and adapted to connect with at least one of said cutting stamp frame and said handle cover.

18. The pizza slice cutting stamp for creating bite size pizza portions from a single slice of pizza of claim 12 wherein said pizza slice cutting stamp further includes a base container adapted to receive a said cutting stamp frame and said handle cover and adapted to connect with at least one of said cutting stamp frame and said handle cover.

19. The pizza slice cutting stamp for creating bite size pizza portions from a single slice of pizza of claim 11 wherein said cutting stamp frame first plurality of inner blade members and said second plurality of inner blade members have a solid plate located therebetween.

20. The pizza slice cutting stamp for creating bite size pizza portions from a single slice of pizza of claim 12 wherein said cutting stamp frame first plurality of inner blade members and said second plurality of inner blade members have a solid plate located therebetween.
